(19) United States
(12) Patent Application Publication
(10) Pub. No.: US 2009/0190673 A1
(43) Pub. Date: Jul. 30, 2009

(54) Power line communication apparatus, integrated circuit for power line communication and transmission/reception methods

(75) Inventors: Hisao Koga, Fukuoka (JP); Nobutaka Kodama, Fukuoka (JP); Yuji Igata, Fukuoka (JP); Akio Kurobe, Osaka (JP); Koji Ikeda, Osaka (JP); Go Kuroda, Osaka (JP)

Correspondence Address: Dickinson Wright PLLC;James E. Ledbetter, Esq., International Square, 1875 Eye Street, N.W., Suite 1200, Washington, DC, 20006, US

(73) Assignee: Matsushita Electric Industrial Co., Ltd., Osaka (JP)

(21) Appl. No.: 11/658,674

(22) PCT Filed: Jun. 13, 2006
(86) PCT No.: PCT/JP06/12206

§ 371 Date: Jan. 29, 2007

(30) Foreign Application Priority Data
Jun. 13, 2005 (JP) 2005-172735

(51) Int. Cl. H04B 3/00

(52) U.S. Cl. 375/257

(57) ABSTRACT

Transmitter 2 includes inverse multicarrier transformer 23 and D/A converter 24. Inverse multicarrier transformer 23 generates a notch by masking a carrier at a frequency location predetermined in accordance with a communication method of the transmitter. D/A converter 24 performs a D/A conversion on a transmission signal containing the notch and transmits the signal to a transmission line. Receiver 1 includes power measurement unit 171, comparator 172 and coexistence signal determination unit 173. Power measurement unit 171 measures a power value of a signal input from the transmission line. Comparator 172 determines whether or not the notch exits by comparing the measured power value with a threshold. Coexistence method determination unit 173 determines the type of coexistence method, based on the location of the detected notch.

### TECHNICAL FIELD

The present invention relates to a power line communication apparatus, an integrated circuit for power line communication, a transmission method and a reception method.

### BACKGROUND ART

When using a terminal such as a computer for wire data communications at homes, offices, factories and the like, it is usually necessary to install wires such as cables and connectors to be used as transmission lines at such locations where they are needed. This requires a wide range of installation work before the communication system goes into operation.

However, at homes, offices and factories, commercial power supply of, for example, 100V AC-50/60 Hz in Japan and 120V AC-60 Hz in the United States of America is generally used. Therefore, power lines (electric lamp lines) for supplying such power are already installed everywhere in homes, offices and factories. Utilizing these power lines for data communications thus eliminates the need to newly install exclusive wires for communications. More specifically, by simply plugging a communication apparatus into a power outlet, a communication line can be secured.

PLC (Power Line Communication) technology using such power lines for communications is disclosed, for example, in Japanese Patent Laid-Open Publication 2000-165304.

In Japan, it is expected that under the laws/regulations frequency bands between 2 MHz and 30 MHz will be allocated for such communications, on which various manufactures are pursuing research and development projects.

### DISCLOSURE OF THE INVENTION

However, no specific standard has been established for the above-described PLC technology. Therefore, each manufacturer uses different specifications for a communication method such as a communication protocol, a modulation method and a frequency band.

Such communication technology is highly likely to be used in an environment where a plurality of types of communication methods are mixed in the same location. For instance, users (communication apparatus users) in collective housing such as an apartment or a condominium do not necessarily use communication apparatuses (e.g., modems) of the same manufacturer. In this case, a plurality of types of communication apparatuses independently made by a plurality of manufacturers may be simultaneously connected to a common power line.

When the plurality of types of communication apparatuses using different types of communication method such as protocols and modulation methods are connected to the common power line, a communication apparatus cannot demodulate a signal transmitted from a communication apparatus using a different type of communication method. Therefore, such a signal is acknowledged merely as noise. Accordingly, although the plurality of types of communication apparatuses use the same frequency band, even the existence of other communication apparatuses is not acknowledged. This causes interference between signals transmitted from the plurality of communication apparatuses, thereby causing communication errors. In other words, the plurality of types of communication apparatuses cannot coexist on the common power line.

Accordingly, as described above, an environment where a plurality of communication apparatuses are connected to a common transmission line such as a power line requires a system that detects whether or not a communication apparatus using a different type of communication method is outputting a signal to the common transmission line.

The present invention is provided to address the above-described problems. A purpose of following descried embodiments is to provide a power line communication, an integrated circuit for power line communication, a transmission method and a reception method that are capable of detecting a state where a communication apparatus using a different type of communication method is outputting a transmission signal to a common transmission line.

The embodiment examples relate to the power line communication apparatus transmitting a transmission signal through a power line, the power line communication apparatus comprising: a notch generator that generates a notch at a predetermined location of frequency characteristics of the transmission signal, the notch indicating, by the predetermined location of the notch, a predetermined communication method used by the power line communication apparatus; and a transmitter that transmits, to another power line communication apparatus through the power line, the transmission signal containing the notch generated by the notch generator.

According to this configuration, it is possible to easily notify a power line communication apparatus connected to the power line of the existence of the communication method of the another power line communication apparatus. Accordingly, it becomes possible to detect a state where a transmission signal is output to the common power line from a power line communication apparatus using a different type of communication method.

The embodiment examples relate to the power line communication apparatus receiving a transmission signal through a power line, the power line communication apparatus comprising: a receiver that receives the transmission signal from another power line communication apparatus through the power line; a frequency characteristics measurement unit that measures frequency characteristics of the transmission signal received by the transmission signal receiver; and a detector that detects a notch from the frequency characteristics measured by the frequency characteristics measurement unit, the notch indicating a predetermined communication method used by the another power line communication apparatus.

According to this configuration, it is possible to detect a state where a transmission signal is output to the common power line from a power line communication apparatus using a different type of communication method, depending on whether or not there is a portion at the predetermined location, i.e., a notch.

### BRIEF DESCRIPTION OF DRAWINGS

FIG. 1 is a block diagram illustrating an example of a schematic configuration of a transmitter and a receiver according to a first embodiment;

FIG. 2 shows an example of frequency characteristics of a transmission signal according to the first embodiment;

FIG. 3 is a conceptual diagram illustrating a measurement method of a reception signal according to the first embodiment;

FIG. 4 is a flowchart illustrating an operation performed by the receiver according to the first embodiment;

FIG. 5 is a block diagram illustrating another example of a schematic configuration of the transmitter according to the first embodiment;

FIG. 6 is a block diagram illustrating another example of a schematic configuration of the receiver according to the first embodiment;

FIG. 7 is a schematic illustrating an example of allocations of communication method identifying notches according to a second embodiment;

FIG. 8 shows an example of attenuation frequency characteristics of a reception signal;

FIG. 9 illustrates a transmission method and a reception method according to a third embodiment;

FIG. 10 is a flowchart illustrating an operation performed by a receiver according to a fourth embodiment;

FIG. 11 is a block diagram illustrating an example of a schematic configuration of a receiver according to a fifth embodiment;

FIGS. 12 (A) and 12 (B) show time characteristics of a signal input from a transmission line;

FIG. 13 is a flowchart illustrating an operation performed by the receiver according to the fifth embodiment;

FIG. 14 is a block diagram illustrating another example of a schematic configuration of the receiver according to the fifth embodiment;

FIG. 15 is a block diagram illustrating a schematic configuration of a receiver according to a six embodiment;

FIGS. 16 (A) and 16 (B) show examples of frequency characteristics of a reception signal;

FIG. 17 is a block diagram illustrating a configuration example of a system in which a plurality of communication apparatuses are connected to a common transmission line;

FIGS. 18 (A) and 18 (B) are conceptual views illustrating a coexistence method when a plurality of different types of communication methods are connected to the common transmission line;

FIG. 19 is an external perspective view of a front side of a communication apparatus according to the embodiments;

FIG. 20 is an external perspective view of a rear side of the communication apparatus according to the embodiments; and

FIG. 21 is a block diagram illustrating an example of hardware of the communication apparatus according to the embodiments.

### BEST MODE FOR CARRYING OUT THE INVENTION

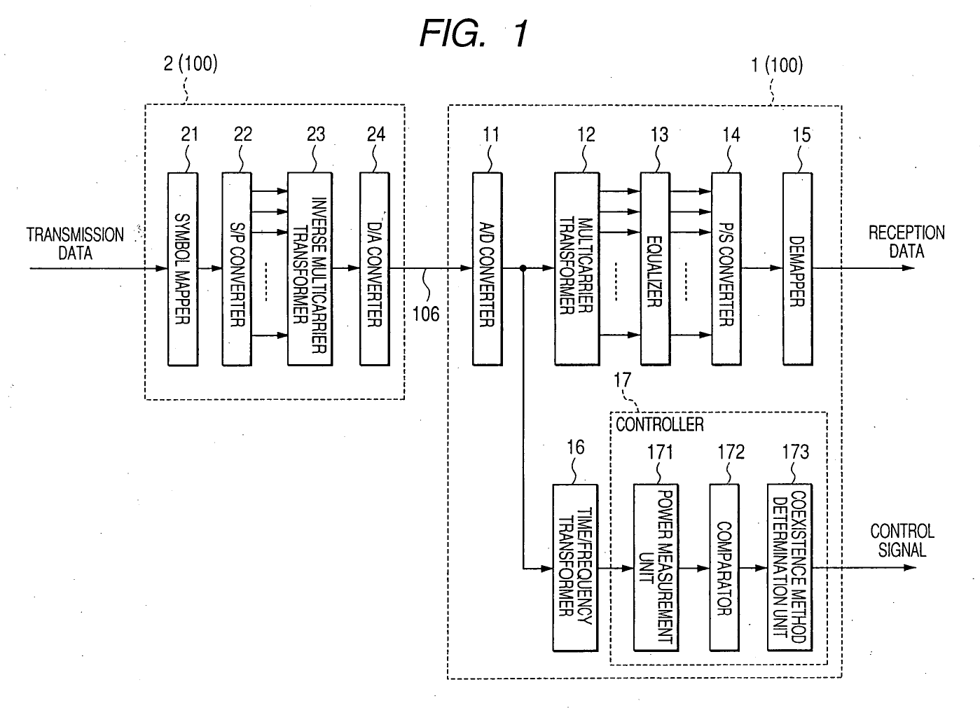

The embodiments are explained in the following with reference to FIGS. 1 through 21.

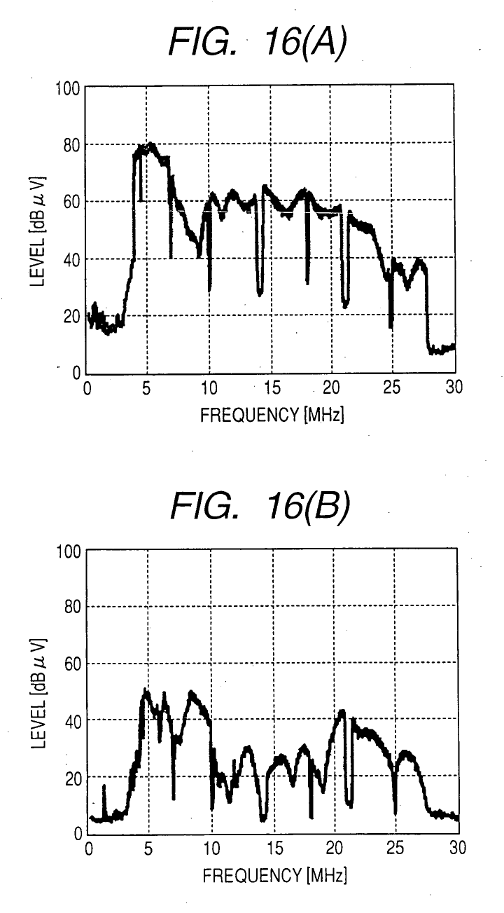

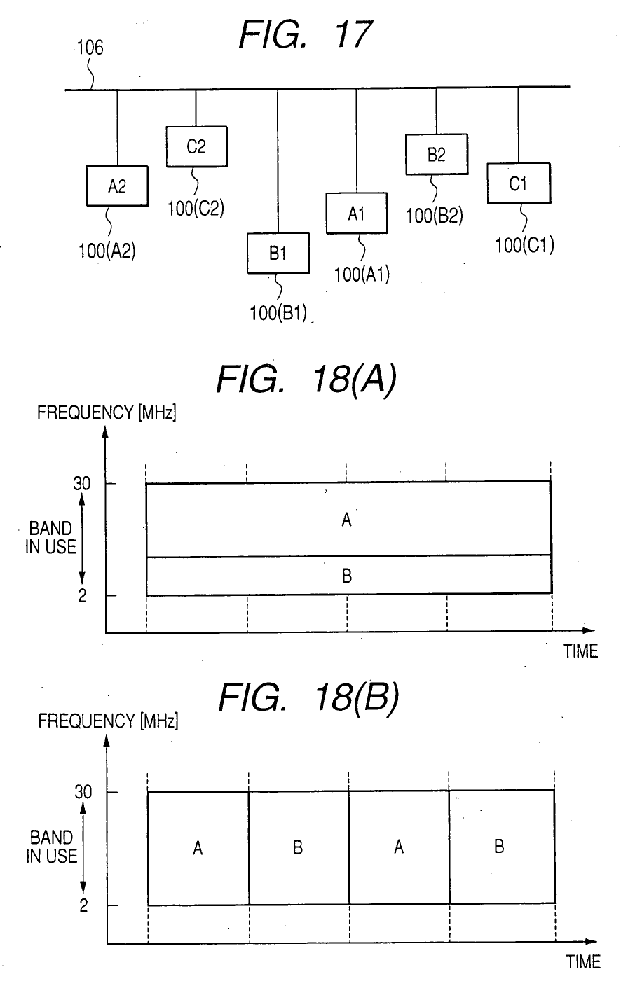

First, a description is provided for a case where communication apparatuses using a plurality of communication methods are connected to a common transmission line. FIG. 17 is a block diagram illustrating a configuration example of a system in which a plurality of communication apparatuses are connected to a common transmission line. In the example indicated in FIG. 17, the plurality of communication apparatuses 100 (A1), 100 (A2), 100 (B1), 100 (B2), 100 (C1), and 100 (C2) are commonly connected to transmission line 1061. Communication apparatuses 100 (A1) and 100 (A2) perform communications using communication method “A”; communication apparatuses 100 (B1) and 100 (B2) perform communications using communication method “B”; and communication apparatuses 100 (C1) and 100 (C2) perform communications using communication method “C”. Here, the “communication method” means a protocol that enables communications between a transmitter and a receiver. For instance, the “communication method” includes a multiple access method (a coexistent method), e.g., frequency division multiple access, time division multiple access, code division multiple access, etc., and a modulation/demodulation method such as OFDM (Orthogonal Frequency Division Multiplexing) and SS (Spread Spectrum). Conceptually, the “communication method” further includes specifications such as symbol rates and frame formats.

Accordingly, communication apparatuses 100 (A1) and 100 (A2) are the same type of apparatuses; communication apparatuses 100 (B1) and 100 (B2) are the same type of apparatuses; and communication apparatuses 100 (C1) and 100 (C2) are the same type of apparatuses. However, communication apparatuses 100 (A1) and 100 (A2), communication apparatuses 100 (B1) and 100 (B2) and communication apparatuses 100 (C1) and 100 (C2) are different types of apparatuses. Such different types of apparatuses use different types of communication methods such as communication protocols, data signal modulation methods, and symbol rates.

Power line communication, for example, can be used in the above-described environment. More specifically, although collective housing, for example, includes a plurality of independent residences as users, such collective housing uses a common power line. Therefore, power lines installed in respective residences are mutually electrically connected. On the other hand, since the users of the respective residences do not necessarily use communication apparatuses of the same manufacturer (namely, the same communication method), the users of the respective residences may use different types of communication apparatuses 100. In other words, communication apparatuses 100 made by different manufacturers may use different types of communication methods such as communication protocols, data signal modulation methods and symbol rates.

As described above, when the plurality of different types of communication apparatuses 100 are connected to common transmission line 106, each communication apparatus 100 cannot demodulate a signal transmitted from a different type of communication apparatus 100. Therefore, even the existence of the different type of communication apparatus 100 cannot be detected. As a result, interference between signals transmitted from the plurality of different types of communication apparatuses 100 occurs on transmission line 106. When such signal interference occurs, no communication can be performed. Therefore, the plurality of different types of communication apparatuses 100 cannot coexist on transmission line 106 unless under special control.

FIGS. 18 (A) and 18 (B) are conceptual diagrams illustrating a coexistence method in which a plurality of communication apparatuses using different methods are connected to the common transmission line. FIG. 18 (A) shows a case where the coexistence method is based on frequency division; and FIG. 18 (B) shows a case where the coexistence method is based on time division.

As shown in FIG. 18 (A), when frequency bands used for communications are, for example, between 2 and 30 MHz, communication methods A and B can be used on the common transmission line, when communication method A uses a frequency band of 15-30 MHz and communication method B uses a frequency band of 2-15 MHz.

In the coexistence method based on time division as shown in FIG. 18 (B), communication methods A and B can coexist on the common transmission line by, for example, switching between the two communication methods at predetermined time intervals.

In this example, interference between signals transmitted by different types of communication methods can be prevented by performing communications only by using a frequency band or a time slot predetermined in accordance with each communication method. However, when a plurality of communication methods are not used for communications, it is preferable that the entire frequency band be used for one communication method used for the communications, in order to achieve high transmission efficiency.

For instance, when only communication method A is used for communications, the communication apparatuses using communication method A use the entire band (2-30 MHz). When the communication apparatuses using communication method B that preferentially occupies only the frequency band of 2-15 MHz start communications, the communication apparatuses using communication method A detect signals transmitted by communication method B and switch to the coexistence process in accordance with communication method B, in which only the frequency band of 16-30 MHz is used while the frequency band of 2-15 MHz is unused for the communications. This enables the communication apparatuses using the plurality of communication methods to perform communications on the common transmission line while achieving high communication efficiency.

In the first through sixth embodiments, descriptions are provided for a transmitter and a receiver that detect whether or not a communication apparatus using a different type of communication method is outputting a signal to a transmission line, and identify the detected communication method, so as to perform the coexistence process in accordance with the identified communication method. The transmitter and the receiver can perform efficient communications while avoiding interference between signals, even when the communication apparatus using the different type of communication method is connected to the common transmission line such as a power line.

The following describes a communication apparatus applicable as the transmitter and the receiver according to the first through sixth embodiments. In the embodiments, the communication apparatus performing broadband communications (2-30 MHz) using a multi-carrier communication method and a power line as the transmission line is used as an example. The communication apparatus according to the embodiments does not necessarily have to use the multi-carrier communication method and can also use a single-carrier communication method or a spectrum spread method. Also, transmission lines other than power lines can also be used for such communications. For instance, such transmission lines as a coaxial line, a telephone line, a speaker line and a harness can also be used.

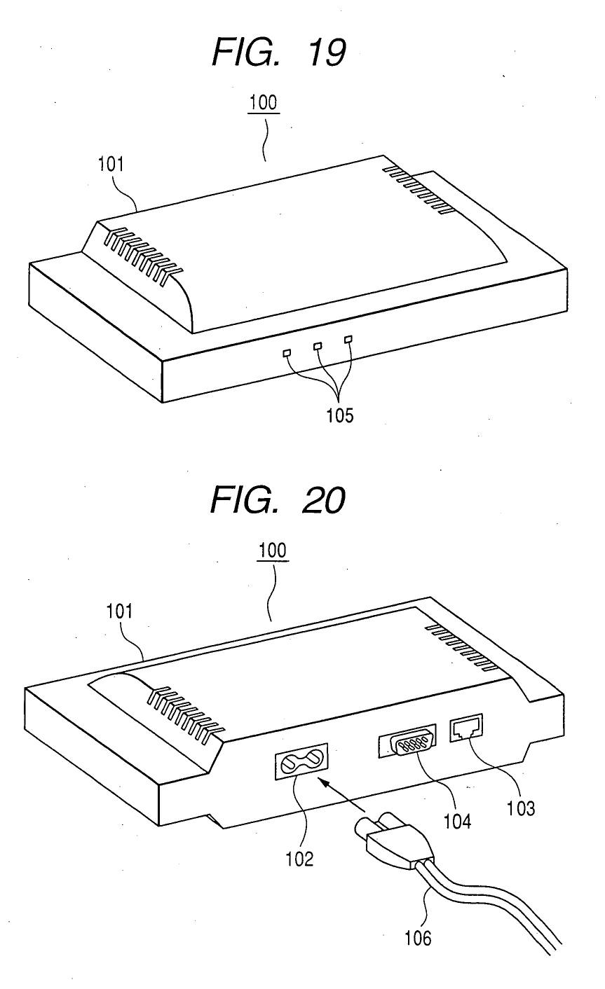

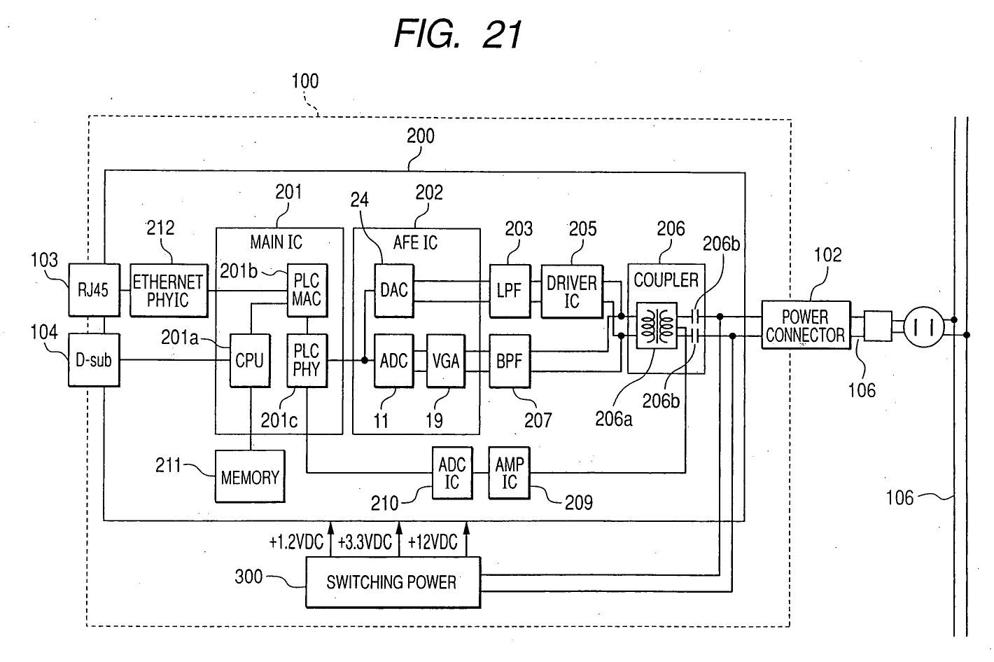

FIG. 19 is an external perspective view of a front side of the communication apparatus according to the embodiments. FIG. 20 is an external perspective view of a rear side of the communication apparatus according to the embodiments.

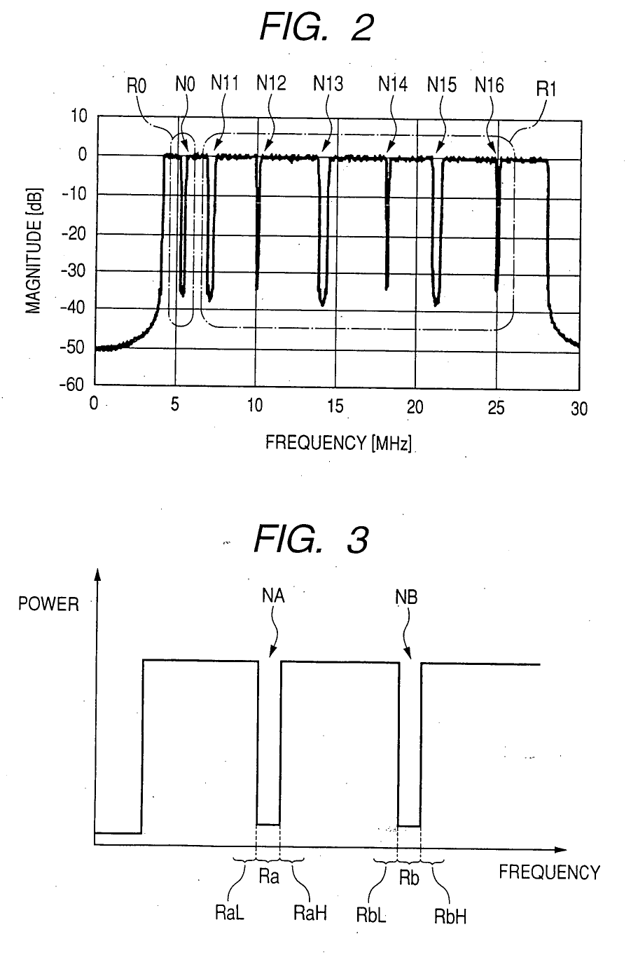

Communication apparatus 100 of the embodiments is a modem as shown in FIGS. 1 and 2. Communication apparatus 100 includes chassis 101. As shown in FIG. 1, display 105, such as LED (Light Emitting Diode), is provided on the front of chassis 101. As shown in FIG. 2, power connector 102 and LAN (Local Area Network) modular jack 103, such as RJ 45, and Dsub connector 104 are provided on the rear of chassis 101. As shown in FIG. 2, power line 106 such as a parallel cable connects to power connector 102. A LAN cable (not shown in the drawing) connects to modular jack 103. A Dsub cable (not shown in the drawing) connects to Dsub connector 104. The modem shown in FIGS. 1 and 2 is illustrated as a mere example of the communication apparatus, and an electric appliance equipped with a modem (e.g., a home electric appliance such as a television set) may be used instead.

FIG. 21 is a block diagram illustrating a hardware example of the communication apparatus. As shown in FIG. 21, communication apparatus 100 includes circuit module 200 and power supply 300 (e.g., a switched mode power supply). Power supply 300 supplies voltages of various levels (+1.2V, +3.3V and +12V) to circuit module 200. Circuit module 200 includes a plurality of integrated circuits, low-pass filter (LPF) 203, driver IC 205, coupler 206 and band-pass filter (BPF) 207. The plurality of integrated circuits, each of which includes semiconductor elements such as main IC (Integrated Circuit) 201, AFE IC (Analog Front End IC) 202, AMP (amplifier) IC 209, ADC (AD converter) IC 210, memory 211, Ethernet (registered trademark) physical layer IC (PHY IC) 212.

Main IC 201 includes CPU (Central Processing Unit) 201a, PLC MAC (Power Line Communication Media Access Control) block 201b, PLC PHY (Power Line Communication Physical layer) block 201c. CPU 201a is equipped with a 32-bit RISC (Reduced Instruction Set Computer) processor. PLC MAC block 201b controls a MAC layer of a transmission signal, while PLC PHY block 201c controls a PHY layer of the transmission signal. AFE IC 202 includes DA converter (DAC) 24, AD converter (ADC) 11, and Variable Gain Amplifier (VGA) 25. Coupler 206 includes coil transformer 206a and condenser 206b.

### First Embodiment

FIG. 1 is a block diagram illustrating a schematic configuration example of a transmitter and a receiver according to a first embodiment. Receiver 1 includes A/D converter 11, multicarrier transformer 12, equalizer 13, P/S converter 14, demapper 15, time/frequency transformer 16 such as FFT/DWT and controller 17. Multicarrier transformer 12, such as a Fourier transformer (FFT) or a wavelet transformer (DWT), performs a desired time/frequency transformation. Equalizer 13 corrects a reception signal to reduce the effect of a transmission line. P/S converter 14 converts parallel data into serial data. Demapper 15 converts mapped symbol data into bit-data as a reception signal. Controller 17 performs a frequency analysis on a signal input from the power line as the transmission line. Controller 17 includes power measurement unit 171, comparator 172, and a coexistence method determination unit 173. Power measurement unit 171 measures power values as an example of frequency characteristics of a signal input from the power line as the transmission line. Comparator 172 compares the measurement results with a threshold. The coexistence method determination unit 173 determines whether or not a signal transmitted from a communication apparatus using a different type of communication method exists and determines the type of used coexistence method when such a signal exists. Time/frequency transformer 16 functions as an example of a time/frequency transformer. Power measurement unit 171 functions as an example of a frequency characteristics measurement unit. Coexistence method determination unit 173 functions as an example of a determination unit. Comparator 172 and coexistence method determination unit 173 are examples of a detector.

PLC MAC block 201b of main IC 201 shown in FIG. 21 includes controller 17. PLC PHY block 201c includes multicarrier transformer 12, equalizer 13, P/S converter 14 and demapper 15. AFE IC 202 includes ADC 11. Controller 17 can be included in PLC PHY block 201c.

Transmitter 2 includes symbol mapper 21, S/P converter 22, inverse multicarrier transformer 23 and D/A converter 24. Symbol mapper 21 performs symbol mapping by converting bit-data as a transmission signal into symbol data. S/P converter 22 converts serial data into parallel data. Inverse multicarrier transformer 23, such as an Inverse Fourier Transformer (IFFT) or an Inverse Wavelet Transformer (IDWT), performs a desired time/frequency transformation. PLC PHY block 201c of main IC 201 shown in FIG. 21 includes symbol mapper 21, S/P converter 22 and inverse multicarrier transformer 23. AFE IC 202 includes D/A converter 24.

Each of Receiver 1 and transmitter 2 can be configured of the multicarrier communication apparatus shown in FIGS. 19 through 21. Receiver 1 can have only reception functions, while transmitter 2 can have only transmission functions.

The following describes a general process for detecting a state where a transmission signal is output from a communication apparatus using a different method to the common transmission line.

FIG. 2 shows an example of frequency characteristics of a transmission signal according to the first embodiment. In this example, a signal band of 2-30 MHz, for example, includes a frequency band used for amateur radio. In FIG. 2, a signal band of 4-28 MHz is used, which has notches N11-N16 at 6 locations to reduce effects to the frequency band for amateur radio. A notch here refers to a portion whose gain at a predetermined frequency location is lower than gains at its adjacent frequency locations. A frequency location refers to a location on a frequency axis, more specifically to a predetermined frequency or a band including the predetermined frequency.

Besides notches N11-N16, transmitter 2 of the present embodiment generates a transmission signal containing notch N0 for identifying the type of communication method (hereinafter referred to as a communication method identifying notch). For instance, communication method identifying notch N0 is generated so as to be provided at a predetermined frequency location (e.g., 5 MHz or 6 MHz), based on the communication method of the transmitter. Receiver 1 then determines whether or not a signal transmitted from the transmitter using a different type of communication method is included, and identifies the type of communication method including a multiple access method, depending on whether or not the reception signal contains communication method identifying notch N0 predetermined in accordance with, for example, the communication method. Receiver 1 then executes the coexistence process in accordance with the identified type of communication method.

FIG. 3 is a conceptual diagram illustrating a measurement method of a reception signal according to the first embodiment. In this example, for instance, the transmitter that uses the coexistence method based on frequency division as shown in FIG. 18 (A) transmits a transmission signal containing communication method identifying notch NA at 5 MHz; and the transmitter that uses the coexistence method based on time division as shown in FIG. 18 (B) transmits a transmission signal containing communication method identifying notch NB at 6 MHz. The transmitter can use both coexistence methods based on frequency division and time division. In this case, a transmission signal containing both communication method identifying notches NA and NB is transmitted.

Receiver 1 can detect whether or not the notch is included by measuring power values of the following frequency bands: frequency band Ra as an example of a frequency location including 5 MHz at which communication method identifying notch NA is provided; frequency bands RaL and RaH as examples of frequency locations adjacent to frequency band Ra; frequency band Rb as an example of a frequency location including 6 MHz at which communication method identifying notch NB is provided; and frequency bands RbL and RbH as examples of frequency locations adjacent to frequency band Rb. Accordingly, receiver 1 can detect whether or not a communication signal using a different type of communication method is transmitted to the transmission line, by determining whether or not the notches are provided at the predetermined locations, and further specifies the type of communication method based on the notch's locations, thereby enabling a corresponding coexistence process.

The following describes an operation of the communication apparatus configured as described above.

Transmitter 2 converts bit-data (transmission data) transmitted from symbol mapper 21 into symbol data, and performs symbol mapping (modulation such as PAM and QAM) onto a complex coordinate plane according to each packet of the symbol data. The transmission data are transmitted from PLC MAC 201b. Then, S/P converter 22 assigns a real value (or a complex value) to each subcarrier, and inverse multicarrier transformer 23 converts these values into a spread multicarrier signal. This process produces sampling values for a time-axis waveform, and generates a sampling value sequence indicating transmission symbols. Then, after a P/S converter (not shown in the drawing) converts the sampling value sequence into serial data, D/A converter 24 generates a transmission signal in a baseband analog signal waveform that is temporally contiguous.

As shown in FIG. 2, when notches are provided at predetermined locations, inverse multicarrier transformer 23 generates the notches by disusing subcarriers corresponding to the predetermined locations for the notches (namely, the subcarriers are masked). Then, a transmission signal containing the notches in its frequency characteristics is transmitted to the power line (power line 106) through D/A converter 24. Multicarrier transformer 23 functions as a notch generator. D/A converter 24, LPF 203, driver IC 205 and coupler 206 function as a transmission signal transmitter.

Receiver 1 converts an analog signal received via power line 106 or the like into a digital baseband signal at A/D converter 11 by sampling the analog signal at the same sampling rate as transmitter 2, and converts the digital baseband signal into a sampling value sequence in parallel at an S/P converter (not shown in the drawing). The sampling value sequence is input into multicarrier transformer 12, where the input data are converted into a spread multicarrier signal on the frequency axis while being synchronized with the reception signal in a synchronization circuit (not shown in the drawing). Equalizer 13 equalizes the converted data based on an equalization amount calculated in comparison with pre-allocated given data. Then, P/S converter 14 converts the equalized data into a serial signal, and demapper 15 executes a process opposite to the process executed by the symbol mapper (demodulation) in order to obtain the reception data. The reception data are transmitted to PLC MAC block 201b.

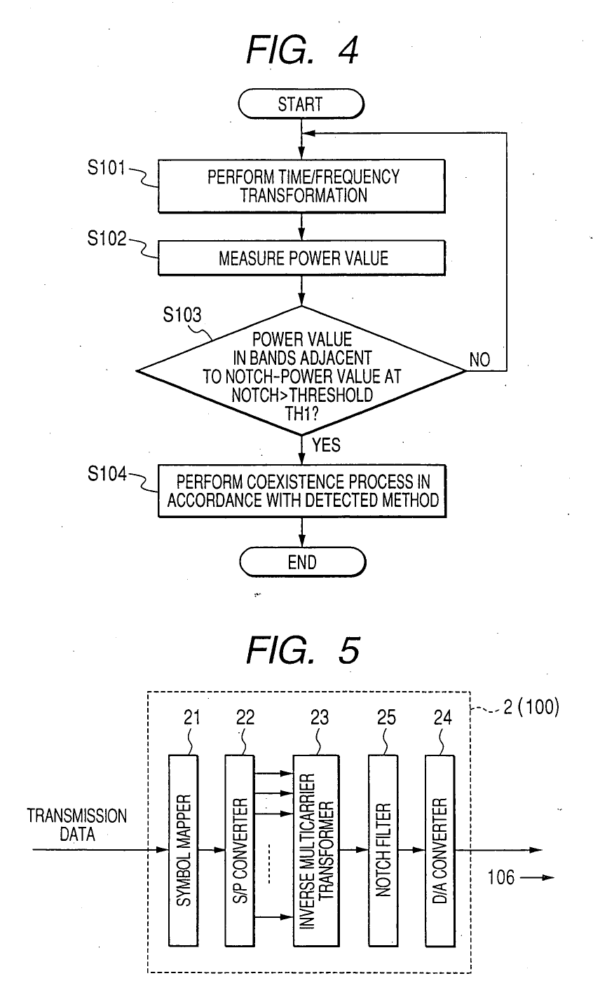

The following describes an operation executed by time/frequency transformer 16 and controller 17 with reference to FIG. 4. FIG. 4 is a flowchart illustrating a process executed by the receiver according to the first embodiment.

As shown in FIG. 4, time/frequency transformer 16 performs a time/frequency transformation on a signal digitalized by A/D converter 11 (step S101). Then, power measurement unit 171 measures power values of a frequency-transformed signal, e.g., average power values at the frequency location containing the communication method identifying notch and at its adjacent frequency locations (step S102). For instance, as shown in FIG. 3, power values in frequency bands Ra, RaL and RaH and power values in frequency bands Rb, RbL and RbH are measured.

Comparator 172 makes the following comparison: a value is compared with predetermined threshold TH1, the value being obtained after the power value at the frequency location containing the communicant method identifying notch is subtracted from the power values at its adjacent frequency locations. For instance, when the average power values in frequency bands Ra, RaL and RaH are P(Ra), P(RaL) and P(RaH), respectively, the difference between average power values P(RaL) and P(Ra), and the difference between average power values P(RaH) and P(Ra) are respectively calculated, after which the results are compared with threshold TH1. It is also possible to evaluate P(RaL)+P(RaH)−P(Ra) and compare the result with threshold TH1. This formula is useful when the difference between P(RaL) and P(RaH) is great due to the effects of the transmission line.

When the comparison result yielded by comparator 172 is smaller than threshold TH1 (step S103: No), coexistence method determination unit 173 determines that a signal containing the communication method identifying notch has not been received, after which the process returns to step S101.

On the other hand, when the comparison result yielded by comparator 172 is greater than threshold TH1 (step S103: Yes), coexistence method determination unit 173 determines that a signal containing the communication method identifying notch has been received, namely that a signal is being transmitted to the transmission line from a communication apparatus using a different type of communication method. Coexistence method determination unit 173 then detects the different type of communication method.

Coexistence method determination unit 173 then identifies the different type of communication method by the location of the detected communication method identifying notch, and outputs a control signal to execute the coexistence process in accordance with the identified type of communication method. The output control signal is transmitted to PLC MAC block 201b, after which the coexistence process is performed (step S104). The coexistence process is a communication method in which the detected communication method occupies the frequency band lower than 15 MHz, for example, and communications are performed only in the frequency band higher than 15 MHz, when the coexistence method is based on frequency division.

It is preferable that frequency characteristics of the communication method identifying notch be precipitous characteristics to be distinctively identified when considering such factors as transmission rate. However, there may be a case where desired characteristics of the notch cannot be obtained through a transformation method by inverse multicarrier transformer 23. In such a case, the transmitter indicated in FIG. 5 can be used.

FIG. 5 is a block diagram illustrating another example of a schematic configuration of the transmitter according to the first embodiment. Components identical to those of FIG. 1 are assigned the same numbers. The communication apparatus shown in FIG. 5 includes notch filter 25 at the output side of inverse multicarrier transformer 23. Notch filter 25 is a digital filter that reduces a gain in a desired frequency. Accordingly, the precipitous characteristics of the notch can be achieved by reducing the gain at the frequency location containing the communication method identifying notch in accordance with the communication method of the transmitter. In this case, notch filter 25 functions as a notch generator.

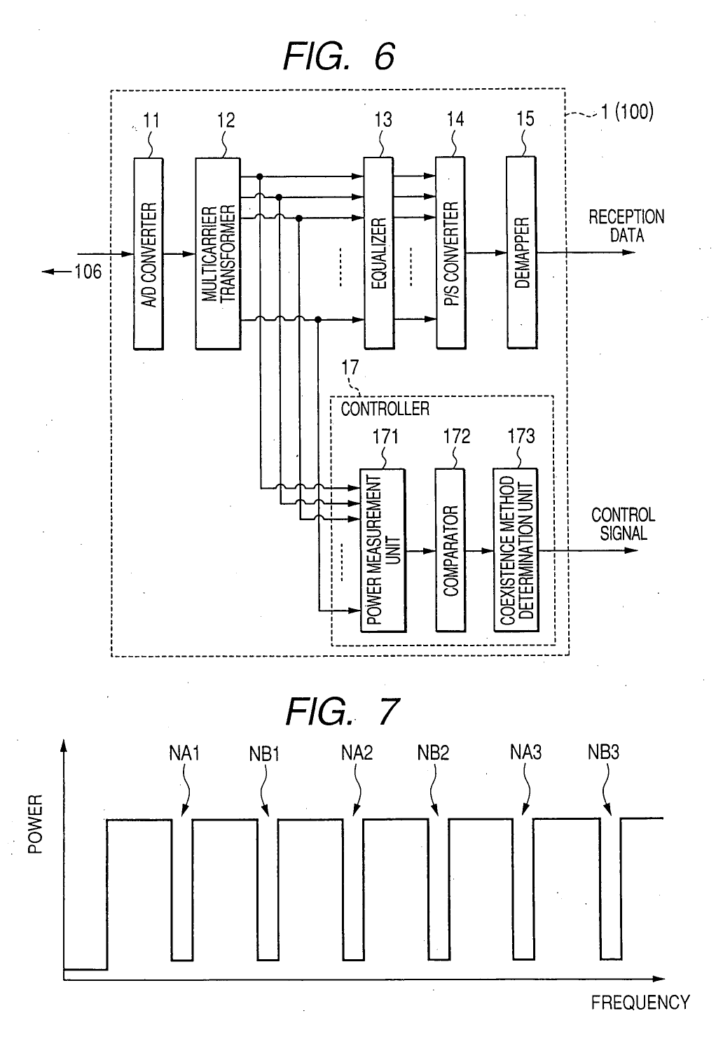

In receiver 1, since multicarrier transformer 12 has already executed a time/frequency transformation, the results of the transformation can be used to detect the communication method identifying notch. FIG. 6 is a block diagram illustrating another example of a schematic configuration of the receiver according to the first embodiment. As shown in FIG. 6, power measurement unit 171 of controller 17 measures the power value of each subcarrier signal input from multicarrier transformer 12, instead of using signals input from time/frequency transformer 16. Accordingly, since the blocks of a time/frequency transformation are shared, its processing load can be reduced. Multicarrier transformer 12 functions as an example of a time/frequency transformer.

In the example indicated in FIG. 3, a description has been provided for a case where the power value in the frequency band including the frequency allocated for the communication method identifying notch is compared with the power values in its adjacent frequency bands that are immediately higher and lower than the frequency band. However, it is also possible to compare only one of the adjacent frequency bands that are immediately higher and lower than the frequency band, with the frequency band. It is also possible to compare frequency bands in the vicinity of the frequency band including the frequency allocated for the communication method identifying notch, instead of its adjacent frequency bands, with the frequency band.

Moreover, a description has been provided as above for a case where the multi-carrier communication method is used. However, the description also applies to a single-carrier communication method or a spectrum spread method. For instance, in the spectrum spread method, transmitter 2 includes a spectrum spread unit and a notch filter at its subsequent stage, instead of S/P converter 22 and inverse multicarrier transformer 23, so as to transmit a transmission signal containing the communication method identifying notch at a location indicating the coexistence method in accordance with the communication method of the transmitter. Receiver 1 includes an inverse spectrum spread unit, instead of multicarrier transformer 12, equalizer 13 and P/S converter 14, so as to demodulate reception data.

In the first embodiment, transmitter 2 is capable of easily notifying the communication apparatus connected to the common transmission line of the existence of the communication method of the transmitter, by providing the notch at the frequency location in accordance with the communication method. Receiver 1 is capable of detecting the existence of a signal transmitted by a different type of communication method by determining whether or not the reception data include the notch in a predetermined frequency band. Receiver 1 is also capable of identifying the different type of communication method by the location of the frequency band including the notch. Then, the coexistence process in accordance with the identified type of communication method can be executed.

### Second Embodiment

The following describes a transmitter and a receiver according to a second embodiment. The configurations of the transmitter and the receiver according to the present embodiment are identical to those of the transmitter and the receiver according to the first embodiment.

FIG. 7 is a conceptual diagram illustrating an example of allocations of communication method identifying notches according to the second embodiment. The transmitter according to the present embodiment provides communication method identifying notches at a plurality of different frequency locations corresponding to respective communication methods. For instance, as shown in FIG. 7, communication method identifying notches NA1-NA3 are allocated to three different frequency locations for communication method A, while communication method identifying notches NB1-NB3 are allocated to three different frequency locations for communication method B.

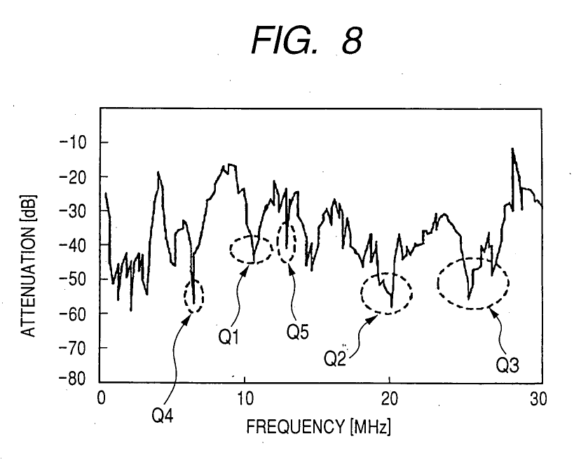

FIG. 8 shows an example of attenuation frequency characteristics of a reception signal. As shown in FIG. 8, due to characteristics of a transmission line, a signal received by the receiver has the attenuation frequency characteristics. Since various appliances are connected to transmission lines, especially such power lines, and their conditions of use vary, such a reception signal is susceptible to the transmission characteristics.

As indicated by parts Q1, Q2 and Q3 in FIG. 8, when significant attenuation characteristics exist in a broad frequency band, communication method identifying notches may be included at these locations. When the frequency band containing the communication method identifying notches is included in parts Q1, Q2 and Q3, attenuation in the vicinity of the notches are so great that the notches cannot be detected.

In transmitter 2 according to the present embodiment, inverse multicarrier transformer 23 and/or notch filter 25 generates notches at a plurality of different allocated frequency locations. For instance, when the transmitter uses communication method A, communication method identifying notches NA1-NA3 are generated as indicated in FIG. 7.

Receiver 1 checks whether or not the notch exists by measuring frequency characteristics of six frequency bands including the frequency locations of communication method identifying notches NA1-NA3 and NB1-NB3, and frequency characteristics of their adjacent frequency bands.

There are two following methods as an example of a method for detecting the communication method identifying notch.

In the first method, comparator 172 of receiver 1 calculates the differences of average power values for the frequency characteristics of six frequency bands including communication method identifying notches NA1-NA3 and NB1-NB3 and their adjacent frequency bands. Then, comparator 172 combines, for each communication method, the results (the differences of the average power values) detected at the frequency locations of the plurality of communication method identifying notches, and compares each of the combined results with threshold TH1. When the result is greater than threshold TH1, a reception detection is performed in accordance with a corresponding communication method.

In the second method, comparator 172 counts the number of notches detected/undetected at the frequency locations of the plurality of communication method identifying notches, and identifies, for example, the type of communication method that has the greatest number of detected notches, based on the comparison results for each communication method. A signal reception detection is then performed in accordance with the identified type of communication method. For instance, when communication method identifying notches NA1 and NA2 are detected while NA3 is not detected, it is determined that a signal transmitted by communication method A has been received, since the number of detected notches is two, while the number of undetected notches is one.

According to the second embodiment as described above, it is possible to make a judgment based on a plurality of communication method identifying notches. This enables more accurate detection by reducing notch detection errors caused by the characteristics and the like of the transmission line and missed detection.

### Third Embodiment

The following describes a transmitter and a receiver according to a third embodiment. Configurations of the transmitter and the receiver according to the present embodiment are identical to those of the transmitter and the receiver according to the first embodiment.

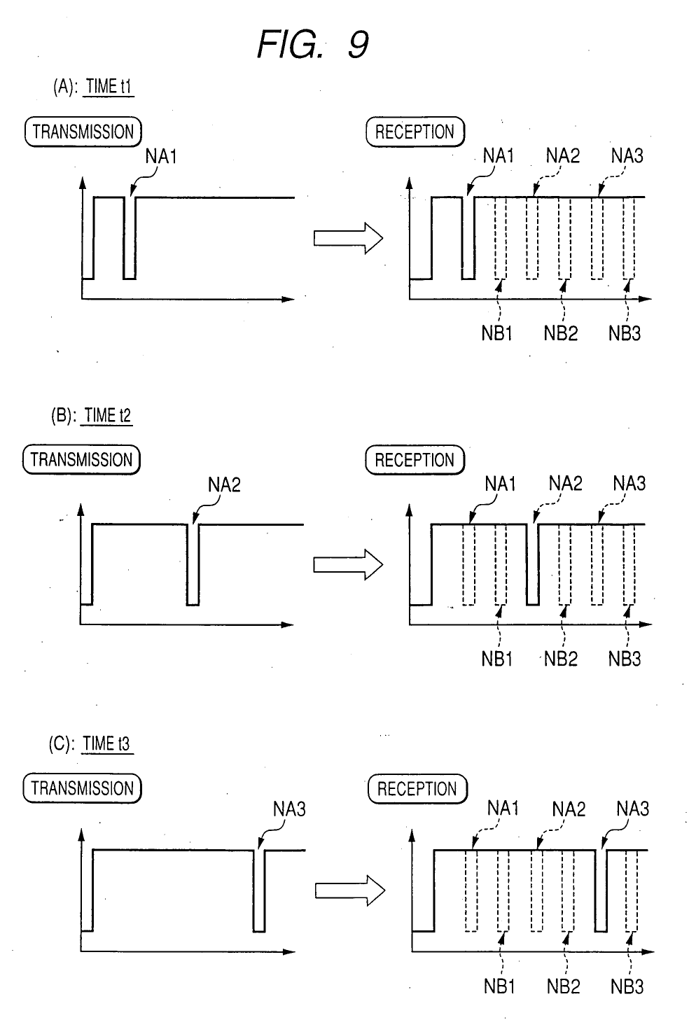

FIG. 9 illustrates transmission and reception methods according to the third embodiment. As shown in FIG. 9, the transmission method according to the present embodiment sequentially generates a communication method identifying notch at least at one of frequency locations allocated in accordance with time passage.

As with FIG. 7, a description is provided for a case where communication method identifying notches NA1-NA3 are allocated to three different frequency locations for communication method A, while communication method identifying notches NB1-NB3 are allocated to three different frequency locations for communication method B. Transmitter 2 performs communications by communication method A.

Transmitter 2 transmits a transmission signal containing communication method identifying notch NA1 at time t1; transmits a transmission signal containing communication method identifying notch NA2 at time t2; and transmits a transmission signal containing communication method identifying notch NA3 at time t3. Accordingly, among communication method identifying notches NA1-NA3, for example, transmitter 3 periodically transmits different notches.

Receiver 1 checks frequency characteristics of frequency bands corresponding to communication method identifying notches NA1-NA3 and NB1-NB3 at each timing. When the communication method identifying notch is detected, receiver 1 executes a coexistence process in accordance with a corresponding communication method.

According to the third embodiment, it is possible to make a judgment based on a plurality of communication method identifying notches. This enables more accurate detection by reducing notch detection errors caused by the characteristics and the like of the transmission line and missed detection. In addition, since a signal is transmitted by selecting one of the plurality of communication method identifying notches that are allocated for different times, transmission efficiency can be improved, compared to a case in which signals containing all of the plurality of communication method identifying notches are constantly transmitted.

### Forth Embodiment

The following describes a transmitter and a receiver according to a fourth embodiment. Configurations of the transmitter and the receiver according to the present embodiment are identical to those of the transmitter and the receiver according to the first embodiment.

Transmitter 2 according to the present embodiment alternates generation and non generation of a communication method identifying notch in, for example, a predetermined period. For instance, when precipitous characteristics exist in parts Q4 and Q5 of the attenuation characteristics as indicated in FIG. 8, and when communication method identifying notches are allocated to these locations, it is impossible to tell whether these portions indicate the attenuation characteristics of a transmission line or the communication method identifying notches.

Therefore, transmitter 2 alternates generation and non generation of the communication method identifying notch, while receiver 1 checks the characteristics in, for example, a predetermined period. Receiver 1 then determines whether the precipitous characteristics in the frequency bands indicate the attenuation characteristics of the transmission line or the communication method identifying notches.

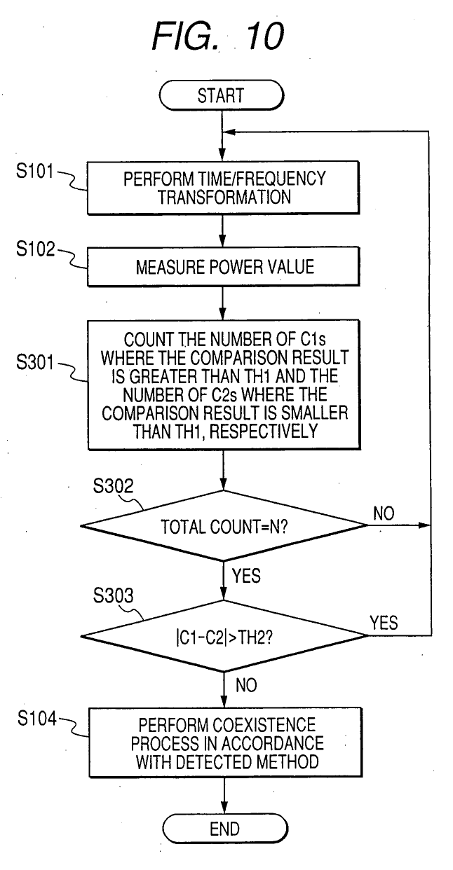

FIG. 10 is a flowchart illustrating operational procedures performed by the receiver according to the fourth embodiment. In FIG. 10, steps identical to those of FIG. 4 described in the first embodiment are assigned the same numbers.

As shown in FIG. 10 according to the present embodiment, steps S101-S102 are performed, where coexistence method determination unit 173 determines whether or not the communication identifying notch exists. Then, coexistence method determination unit 173 counts the number of occasions when the communication method identifying notch is detected as C1 and when the communication method identifying notch is not detected as C2 (step S301). Steps S101-S301 are repeated until the total counts of C1 and C2, respectively, namely the numbers of occasions when the communication method identifying notch is detected/undetected, reach predetermined number N (step S302).

When the total count reaches N (or a predetermined time has passed since the process for detecting the communication method identifying notch started) (step S302: Yes), the absolute value of the difference between C1 (the number of occasions when the communication method identifying notch is detected) and C2 (the number of occasions when the communication method identifying notch is not detected) is calculated, and the result is compared with threshold TH2. When the absolute value of the difference between C1 and C2 is smaller than threshold TH2 (step S303: No), since it can be determined that the detection difference has been acknowledged by checking communication method identifying notches generated/not generated by transmitter 2, it is determined that a different type of communication method has been detected, after which the coexistence process in accordance with the different type of communication method (step S104).

On the other hand, the absolute value of the difference between C1 and C2 is greater than threshold TH2 (step S303: Yes), it can be determined that the communication method identifying notch is not transmitted from transmitter 2 (the number of undetected notches becomes significantly great), or precipitous characteristics are detected in the communication method identifying notch (the number of detected notches becomes significantly great). Therefore, it is determined that a signal transmitted by a different type of communication method does not exist or cannot be detected, and the process thus returns to step S101.

According to the fourth embodiment, it is possible to make a judgment based on generated/not generated communication method identifying notches. This enables more accurate detection by reducing notch detection errors caused by the characteristics and the like of the transmission line and missed detection.

### Fifth Embodiment

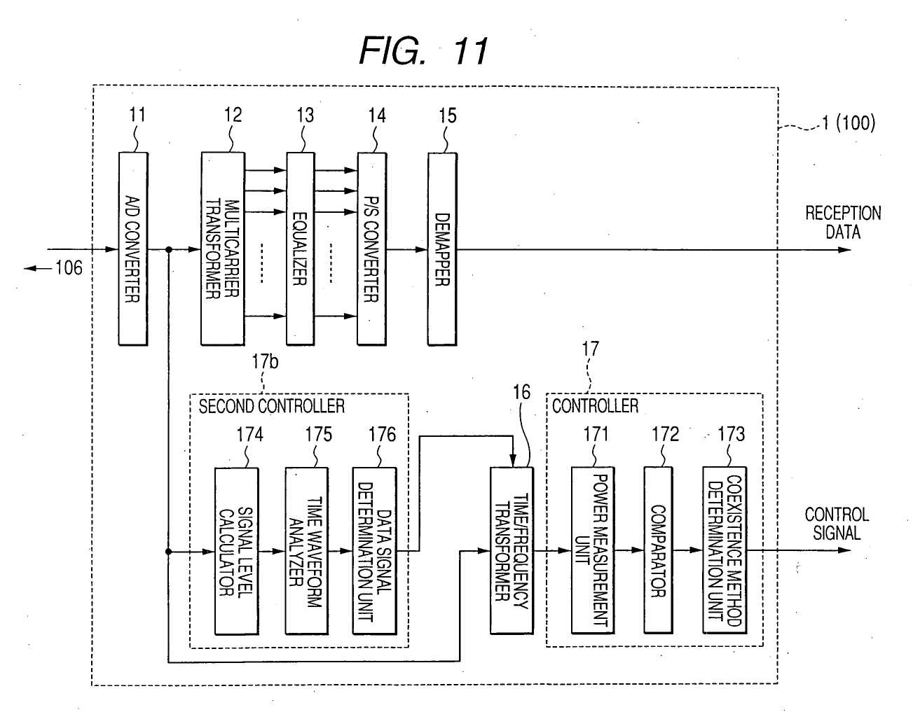

FIG. 11 is a block diagram illustrating an example of a schematic configuration of a receiver according to a fifth embodiment. Components identical to those of FIG. 1 described in the first embodiment are assigned the same numbers.

As indicated in FIG. 11, receiver 1 of the present embodiment further includes second controller 17b including signal level calculator 174, time waveform analyzer 175 and data signal determination unit 176, which are not included in the receiver indicated in FIG. 1. Second controller 17b is included in PLC MAC block 210b shown in FIG. 21, as is controller 17. Time waveform analyzer 175 functions as an example of a time characteristics measurement unit. Data signal determination unit 176 functions as an example of a signal determination unit.

Signal level calculator 174 calculates a signal level of a signal input from a transmission line, the signal output from A/D converter 11. Time waveform analyzer 175 generates time characteristics of the signal level, which was calculated by signal level calculator 174. Data signal determination unit 176 determines whether or not the received signal is a data signal from a different type of communication apparatus, based on the time characteristics generated by time waveform analyzer 175.

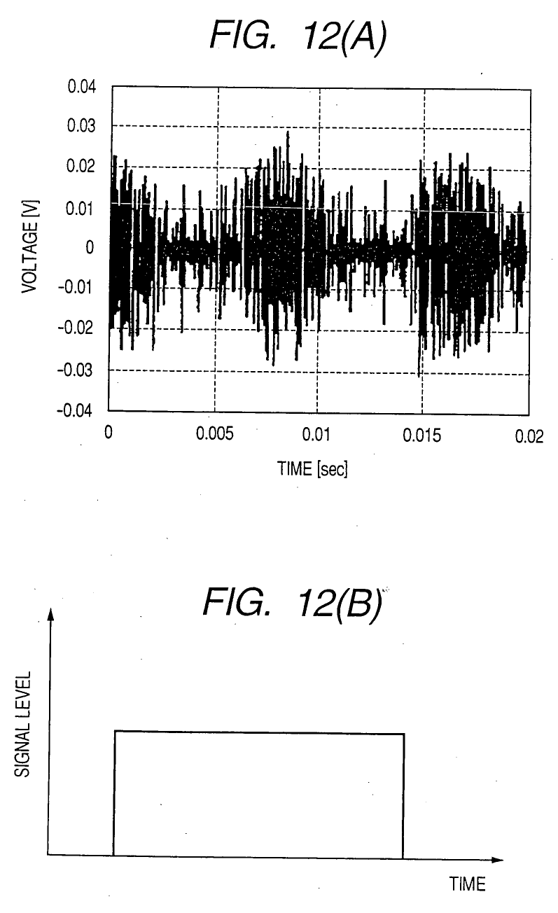

FIGS. 12 (A) and 12 (B) illustrate the time characteristics of the signal input from the transmission line. Time waveform analyzer 175 analyzes a time waveform indicated in FIGS. 12 (A) and 12 (B), which was calculated by signal level calculator 174. FIG. 12 (A) indicates the time waveform of the signal level affected by noises from a different appliance connected to the power line. FIG. 12 (B) indicates the time waveform of the signal level for a signal output from a communication apparatus.

As shown in FIG. 12 (A), as for noises and the like that are not signals used for communications, a signal is likely to be sparse with a soft temporal rise and decay. On the other hand, as indicated in FIG. 12 (B), a signal transmitted from the communication apparatus is dense with a sharp temporal rise and decay. Time waveform analyzer 175 is capable of detecting such a waveform with a rise and decay; data signal determination unit 176 is capable of determining whether or not the detected signal is transmitted from the communication apparatus, based on the detected waveform.

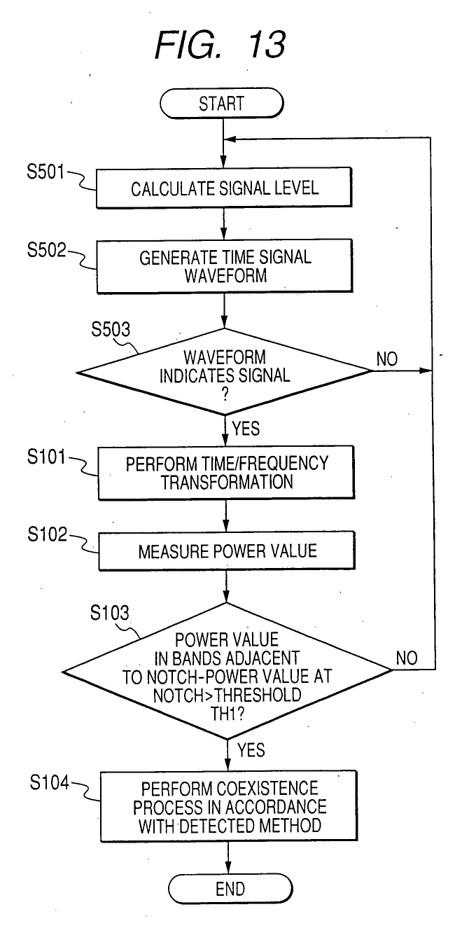

FIG. 13 is a flowchart illustrating a process performed by the receiver according to the fifth embodiment. First, signal level calculator 174 calculates the signal level of a signal input from the transmission line (step S501). Then, time waveform analyzer 175 analyzes the time waveform of the signal (step S502). Next, data signal determination unit 176 determines whether or not the waveform indicates that the signal is from the communication apparatus (step S503).

When it is determined that the waveform indicates noises produced by a different appliance (step S503: No), but not the signal from a communication apparatus, the process returns to step S501. On the other hand, when it is determined that the waveform indicates the signal from a different communication apparatus (step 503: Yes), the process proceeds to determine whether or not the communication method identifying notch exists and perform a corresponding coexistence process, as indicated in steps 101-104 in the first embodiment.

In other words, the receiver according to the present embodiment performs a process for determining whether or not the communication method identifying notch exists only after detecting a signal from the different communication apparatus. Therefore, the process for determining whether or not the communication method identifying notch exists is performed only for a signal from the communication apparatus. This reduces possible detection errors and processing workload, since no process is performed for noises and the like from other appliances.

Particularly, a time/frequency transformation that determines whether or not the communication method identifying notch exists consumes large amounts of power. The detection process based on time characteristics in steps S501-S503 is performed only for a signal from the communication apparatus, based on frequency characteristics. Therefore, power consumption can be reduced by decreasing the overall frequency of detection processes through concentrating on a detection process performed in steps S101-S104, only for a signal from the communication apparatus.

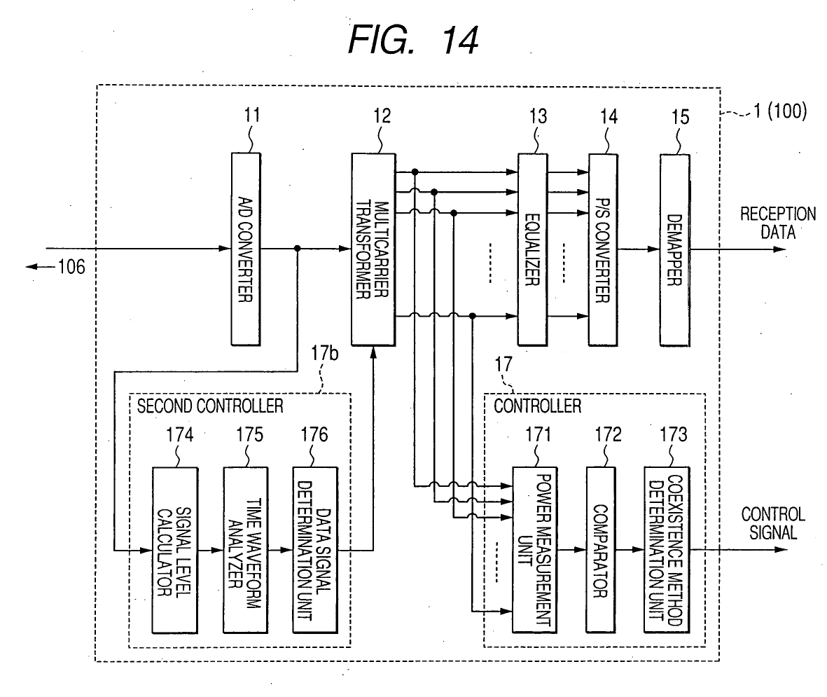

FIG. 14 is a block diagram illustrating another example of a schematic configuration of the receiver according to the fifth embodiment. Since multicarrier transformer 12 has already performed a time/frequency transformation, the fifth embodiment can be configured so that multicarrier transformer 12 is notified of the results yielded by data signal determination unit 176, and that multicarrier transformer 12 is activated when a signal from a different communication apparatus is detected. Other configurations are the same as those indicated in FIG. 6 in the first embodiment.

According to the fifth embodiment, it is determined whether or not a data signal is transmitted to the transmission line by analyzing time characteristics with relatively low power consumption. This achieves more accurate determination of whether or not a signal transmitted from a different type of communication method exists. Moreover, since the process proceeds to a frequency characteristics analysis, depending on the analyzed time characteristics, unnecessary frequency characteristics analysis is eliminated, thereby reducing power consumption.

It is possible to perform a time characteristics analysis and a frequency characteristics analysis in parallel, in addition to performing the time characteristics analysis before the frequency characteristics analysis as described above. It is further possible to perform the frequency characteristics analysis before the time characteristics analysis.

### Sixth Embodiment

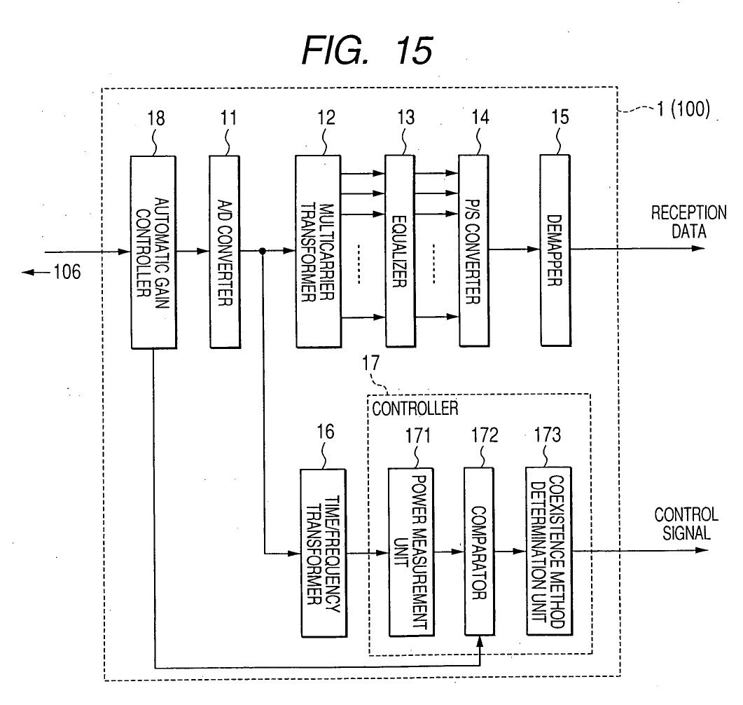

FIG. 15 is a block diagram illustrating a schematic configuration of a receiver according to a sixth embodiment. Components identical to those of FIG. 1 described in the first embodiment are assigned the same numbers.

As described in FIG. 11, receiver 1 according to the present embodiment further includes automatic gain controller 18, which is not included in the receiver of FIG. 1. Values used for gain control by automatic gain controller 18 are input into comparator 172.

Automatic gain controller 18 is included in VGA block 19 of AFE IC 202 shown in FIG. 21. Automatic gain controller 18 amplifies the gain of a signal received from a transmission line.

FIGS. 16 (A) and 16 (B) indicate examples of frequency characteristics of a reception signal. FIG. 16 (A) indicates a case where attenuation due to the characteristics of the transmission line is low, while FIG. 16 (B) indicates a case where attenuation due to the characteristics of the transmission line is high.

As indicated in FIG. 16 (A), when attenuation is low, the receiver can clearly recognize notches generated by the transmitter. However, as indicated in FIG. 16 (B), when attenuation is high, the signal levels of portions adjacent to the notches become low as well. Therefore, the receiver cannot clearly recognize the notches generated by the transmitter. In other words, the differences between the frequency characteristics of the notch portions and those of their adjacent portions become smaller, thereby making it possible to recognize the notches accurately through comparison with the threshold.

Automatic gain controller 18 amplifies a received signal by automatically controlling its gain, depending on the signal level of the received signal. Comparator 172 modifies the threshold, using the value (control signal) used for the gain control.

More specifically, when it is determined, based on the control signal from auto gain controller 18, that the signal level of the received signal is low, namely that attenuation is high, the differences between the notch and its adjacent portions become small, even when the received signal includes a communication method identifying notch. Therefore, comparator 172 lowers threshold TH1 to be used for its determination process. On the other hand, when it is determined that the signal level of the received signal is high, namely that attenuation is low, the differences between the notch and its adjacent portions become great, when the received signal includes the communication method identifying notch. Therefore, comparator 172 raises threshold TH1 to be used for its determination process.

According to the sixth embodiment, the threshold is modified, based on attenuation of the signal received from the transmitting side via the transmission line. This enables high-accuracy judgment, depending on characteristics of the transmission line.

As the receiver described in FIG. 6, time/frequency transformer 16 and multicarrier transformer 12 can be collectively used.

### INDUSTRIAL APPLICABILITY

The transmitter, receiver, transmission method, and reception method according to the present invention have effects of detecting a state where a transmission signal is output from a communication apparatus using a different type of communication method to a common transmission line.

1. A power line communication apparatus transmitting a transmission signal through a power line, the power line communication apparatus comprising:
a notch generator that generates a notch at a predetermined location of frequency characteristics of the transmission signal, the notch indicating, by the predetermined location of the notch, a predetermined communication method used by the power line communication apparatus; and
a transmitter that transmits, to another power line communication apparatus through the power line, the transmission signal containing the notch generated by the notch generator.

2. The power line communication apparatus according to claim 1, wherein the communication method includes a multiple access method.

3. The power line communication apparatus according to claim 1, wherein the notch generator generates the notches at a plurality of different predetermined frequency locations respectively.

4. The power line communication apparatus according to claim 3, wherein the notch generator generates the notches in accordance with time passage.

5. The power line communication apparatus according to claim 1, wherein the notch generator alternates generation and non-generation of the notch.

6. A power line communication apparatus receiving a transmission signal through a power line, the power line communication apparatus comprising:
a receiver that receives the transmission signal from another power line communication apparatus through the power line;
a frequency characteristics measurement unit that measures frequency characteristics of the transmission signal received by the receiver; and
a detector that detects a notch from the frequency characteristics measured by the frequency characteristics measurement unit, the notch indicating a predetermined communication method used by the another power line communication apparatus.

7. The power line communication apparatus according to claim 6, wherein the communication method includes a multiple access method.

8. The power line communication apparatus according to claim 6, further comprising:
a time/frequency transformer that performs a time/frequency transformation on the transmission signal and outputs the transmission signal to the frequency characteristics measurement unit.

9. The power line communication apparatus according to claim 8, wherein the time/frequency transformer is a Fourier transformer.

10. The power line communication apparatus according to claim 8, wherein the time/frequency transformer is a wavelet transformer.

11. The power line communication apparatus according to claim 6, wherein the frequency characteristics measurement unit includes a power measurement unit that measures power values, as the frequency characteristics, at least in the predetermined frequency band and in its adjacent frequency bands.

12. The power line communication apparatus according to claim 6, further comprising:
a time characteristics measurement unit that measures time characteristics of a signal level of the transmission signal; and
wherein the detector that detects the notch based on the measurement results yield by the time characteristics measurement unit.

13. The power line communication apparatus according to claim 6, wherein detector including a comparator that compares, based on the results yielded by the frequency characteristics measurement unit, the differences between the frequency characteristic at the predetermined location and the frequency characteristics at locations adjacent to the predetermined location, with a threshold respectively

14. The power line communication apparatus according to claim 13, wherein the detector sums the comparison results yielded by the comparator for a predetermined period and detects the notch based on the total count.

15. The power line communication apparatus according to claim 13, further comprising:
an automatic gain controller that controls and amplifies a gain of the transmission signal, wherein the comparator modifies the threshold in accordance with a value used for the gain control by the automatic gain controller.

16. The receiver according to claim 13, wherein the frequency characteristics measurement unit measures frequency characteristics at a plurality of different predetermined locations and at their adjacent frequency locations.

17. The power line communication apparatus according to claim 15, wherein, regarding the plurality of measured frequency locations, the comparator combines the differences between the frequency characteristic at each predetermined location and the frequency characteristics at its adjacent frequency locations, and compares the results with the threshold.

18. The receiver according to claim 15, wherein, regarding the plurality of measured predetermined locations, the comparator compares the differences between the frequency characteristic at each predetermined location and the frequency characteristics at its adjacent frequency locations with the threshold, and wherein the determination unit determines, based on the number of the plurality of comparison results corresponding to the plurality of measured predetermined locations, whether or not transmission signals output from the another power line communication apparatus.

19. An integrated circuit for power line communication transmitting a transmission signal, the integrated circuit for power line communication comprising:
a notch generator that generates a notch at a predetermined location of frequency characteristics of the transmission signal, the notch indicating, by the predetermined location of the notch, a predetermined communication method used by the integrated circuit for power line communication; and
a transmitter that transmits the transmission signal containing the notch generated by the notch generator.

20. The integrated circuit for power line communication receiving a transmission signal through a power line, the integrated circuit for power line communication comprising:
a receiver that receives the transmission signal from a power line communication apparatus through the power line;
a frequency characteristics measurement unit that measures frequency characteristics of the transmission signal received by the receiver; and
a detector that detects a notch from the frequency characteristics measured by the frequency characteristics measurement unit, the notch indicating a predetermined communication method used by the power line communication apparatus.

21. A transmission method comprising:
generating a notch at a predetermined location of frequency characteristics of a transmission signal, the notch indicating, by the predetermined location of the notch, a predetermined communication method used by a power line communication apparatus; and
transmitting, to another power line communication apparatus through a power line, the transmission signal containing the generated notch.

22. A reception method comprising:
receiving a transmission signal from a power line communication apparatus through a power line;
measuring frequency characteristics of the received transmission signal; and
detecting a notch from the measured frequency characteristics, the notch indicating a predetermined communication method used by the another power line communication apparatus.
